(19) United States
(12) Patent Application Publication
(10) Pub. No.: US 2016/0006881 A1
(43) Pub. Date: Jan. 7, 2016

(54) Location Services Agent

(71) Applicant: TeleCommunication Systems, Inc., Annapolis, MD (US)

(72) Inventors: Mark Titus, Annapolis, MD (US); Gordon John Hines, Kirkland, WA (US); Paul Thompson, Bothell, WA (US); Joe Hannan, Snoqualmie, WA (US)

(21) Appl. No.: 14/853,749

(22) Filed: Sep. 14, 2015

Related U.S. Application Data
(63) Continuation of application No. 13/348,836, filed on Jan. 12, 2012.
Application No. 13/348,836 is a continuation-in-part of application No. 13/374,104, filed on Dec. 12, 2011, now Pat. No. 9,191,520.
(60) Provisional application No. 61/457,029, filed on Dec. 13, 2010.
(60) Provisional application No. 61/457,138, filed on Jan. 12, 2011.

(51) Int. Cl. H04M 11/04; H04W 68/00; H04W 4/22; H04W 76/00; H04W 4/02; H04L 29/08

(52) U.S. Cl. CPC H04M 11/04; H04W 4/021; H04L 67/18; H04W 4/22; H04W 76/007; H04W 68/005

(57) ABSTRACT

A wireless device Location Services Agent (LSA) provides location functions such as reporting locations to a Location Agent Management Module (LAMM) function in a location services gateway (LSG). The LSA provides a consistent location protocol for providing single shot, periodic triggers and area event triggers. Actual position determination is performed by the native techniques supported by the handset. Location is setup via a Location Agent Management Module (LAMM) component of a Location Services Gateway (LSG) communicating with the LSA. The LSA provides for agent upgrade; SET (handset) registration to the LAMM; Single Shot location determination and conveyance to the LAMM; Periodic Triggered location; Area Event Location; and Privacy Notification and Verification. The LSA interfaces with the LAMM component of the LSG to initialize location requests, and interfaces with external location servers for actual position determination.

This application claims priority from U.S. Provisional No. 61/457,138, entitled “LOCATION SERVICES AGENT,” to Titus et al., filed Jan. 12, 2011; and is a Continuation-In-Part of U.S. patent application Ser. No. 13/374,104 entitled “LOCATION SERVICES GATEWAY SERVER,” to Titus et al., filed Dec. 12, 2011, which in turn claims priority from U.S. Provisional No. 61/457,029, entitled “LOCATION SERVICES GATEWAY SERVER,” to Titus et al., filed Dec. 13, 2010, the entirety of all of which are expressly incorporated herein by reference

### BACKGROUND OF THE INVENTION

1. Field of the Invention

This invention relates to wireless communications. More specifically it relates to provision of location information for wireless devices.

2. Background of the Related Art

Wireless data communications technology solutions exist that require proven high levels of reliability. For instance, wireless data offerings from TeleCommunication Systems, Inc. of Annapolis, Md. (the assignee of the present application) include secure deployable communication systems and engineered satellite-based services; location-based wireless and VoIP Enhanced 9-1-1 services; messaging and location service infrastructure for wireless operators; and commercial location applications, like traffic and navigation, using the precise location of a wireless device. Specifically branded products commercially available from TeleCommunication Systems, Inc. (“TCS”) include Xypoint® Location Platform, Xypoint® Reference Network, Xypoint® Assistance Data Server, and Xypoint® SUPL Server.

### SUMMARY OF THE INVENTION

A method of providing complex Location Based Services including: single-shot, periodic and area event triggers when the underlying Location Protocol provided by the handset does not provide these capabilities. Including generating an area event trigger for a wireless device according to the principles of the present invention, comprising obtaining a plurality of position fixes on a given wireless device being monitored for an occurrence of an area event with respect to a predefined geographical area. It is determined that the area event of the given wireless device has occurred. An area alert message relating to the occurrence of the area event is triggered.

### BRIEF DESCRIPTION OF THE DRAWINGS

Features and advantages of the present invention will become apparent to those skilled in the art from the following description with reference to the drawings, in which:

FIG. 1 shows an LSA within a handset interfaced to an LSG and LAMM, in accordance with the principles of the present invention.

FIG. 2 details an exemplary LSA installation procedure, in accordance with the principles of the present invention.

FIG. 3 shows an exemplary upgrade flow, in accordance with the principles of the present invention.

FIG. 4 shows exemplary SET Registration, in accordance with the principles of the present invention.

FIG. 5 shows a periodic SET Registration whereby the LSA periodically registers with the LAMM to renew its registration, in accordance with the principles of the present invention.

FIG. 6 shows an exemplary Notification Only dialog box for when the received privacy indicates “notification only”, in accordance with the principles of the present invention.

FIG. 7 shows an exemplary Notification and verification dialog box for when the received privacy indicates “notification and verification”, in accordance with the principles of the present invention.

FIG. 8 depicts dialog box requirements when the LSA fails to register with the LAMM, in accordance with the principles of the present invention.

FIG. 9 shows a standard Immediate Service Sequence diagram, in accordance with the principles of the present invention.

FIG. 10 shows Notification based on current position, in accordance with the principles of the present invention.

FIG. 11 shows exemplary call flows for a periodically triggered location service, in accordance with the principles of the present invention.

FIG. 12 shows call flows for area event triggered services, in accordance with the principles of the present invention.

FIG. 13 shows an exemplary LOS client triggered service cancellation procedure, in accordance with the principles of the present invention.

FIG. 14 shows exemplary call flow for the location services agent (LSA) canceling triggered service, in accordance with the principles of the present invention.

FIG. 15 shows exemplary immediate location request exception procedures for user denied positioning, in accordance with the principles of the present invention.

FIG. 16 shows exemplary call flow for general error processing of an immediate location request exception procedure, in accordance with the principles of the present invention.

FIG. 17 shows an error SUPL protocol error, in accordance with the principles of the present invention.

FIG. 18 shows LSA type 1 SMPP user data, in accordance with the principles of the present invention.

FIG. 19 shows LSA type 1 SMPP payload, in accordance with the principles of the present invention.

FIG. 20 depicts LSA SMPP type 2 SMPP user data, in accordance with the principles of the present invention.

### DETAILED DESCRIPTION OF ILLUSTRATIVE EMBODIMENTS

The present inventors have appreciated that missing from the portfolio of products is a component that provides managed control over the delivery of mobile device location information to external systems.

The present invention provides a feature installed on wireless handsets that facilitates location services, referred to herein as a Location Services Agent (LSA), by TeleCommunication Systems, Inc. The term LSA as used herein relates to a location services agent in general—an application executing on a mobile device that provides location functions on a mobile device such as reporting locations to a Location Agent Management Module (LAMM) function in a location services gateway (LSG). The LAMM is a function of the LSG that interfaces to the LSA on a mobile device.

The LSA provides a consistent location protocol for providing single shot, periodic triggers and area event triggers. Actual position determination is performed by the native techniques supported by the handset. Location is setup via the Location Agent Management Module (LAMM) component of the Location Services Gateway (LSG) communicating with the LSA.

The LSA provides for agent upgrade; SET (handset) registration to the LAMM; Single Shot location determination and conveyance to the LAMM; Periodic Triggered location; Area Event Location; and Privacy Notification and Verification

The LSA interfaces with the LAMM component of the LSG to initialize location requests. The LSA interfaces with external location servers for actual position determination. The LSA can be installed by downloading the LSA software from a carrier defined web server.

Location setup between the LAMM and the LSA is via a modified version of the SUPL 2.0 protocol. This approach was taken to minimize the effort of defining a whole new protocol and also allow for future extensions for the LSA to send additional measurement data if it is desired that the LAMM should perform position calculation.

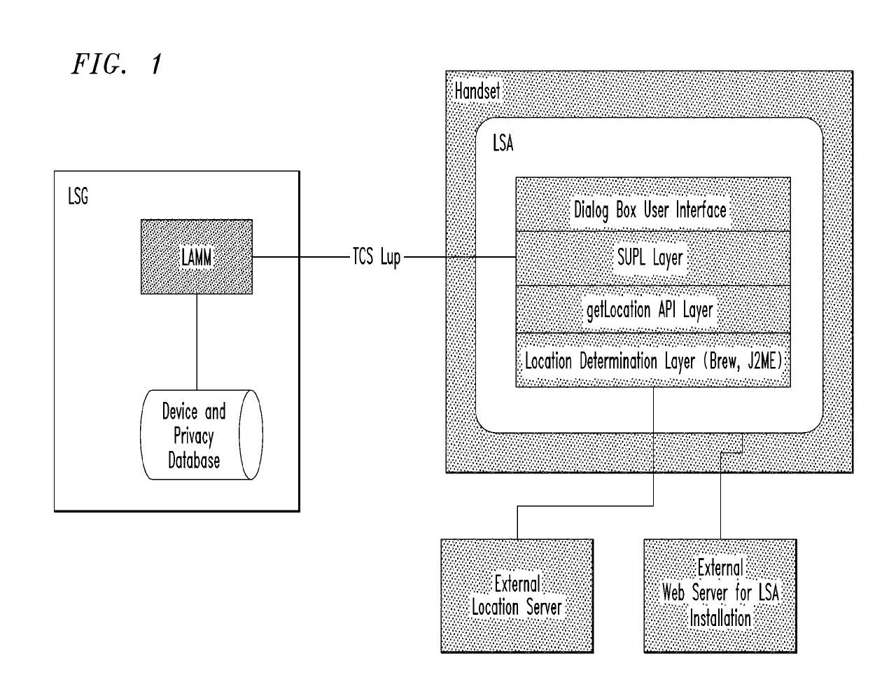

FIG. 1 shows an LSA within a handset interfaced to an LSG and LAMM, in accordance with the principles of the present invention.

An appropriate LSG is shown and described in U.S. Provisional No. 61/457,029, entitled “Location Services Gateway Server” to Titus et al., filed Dec. 13, 2010, and its regular U.S. patent application Ser. No. 13/374,104, filed Dec. 12, 2010 with the same title, the entirety of both of which are explicitly incorporated herein by reference.

The LSA supports JSR179 and JSR293 for J2ME devices. The LSA supports roaming in/out of a carrier network, and is forward compatible with Long Term Evolution (LTE) networks.

A management module authenticates the LSA when it receives the first message from the LSA during device registration or when the LSA responds to the SUPL INIT for immediate location request or triggered location request.

The LSA displays appropriate dialog boxes to support notification type and either continues with positioning, or denies the request. The LSA supports the following NotificationType enumerated values:
noNotificationNoVerification;
notificationOnly;
notificationAndVerificationAllowedNA;
notificationAndVerificationDeniedNA; and
privacyOverride.

The LSA immediately continues the location service call flow if the notification type is “noNotificationNoVerification”. The LSA displays a notification only dialog box for a configurable number of seconds to the user if the notification type is “notification only”. The LSA displays a notification and verification dialog box for a configurable number of seconds to the user if the notification type is “notificationAndVerficationAllowedNA”. The LSA displays a notification and verification dialog box for a configurable number of seconds to the user if the notification type is “notificationAndVerficationDeniedNA”. The LSA immediately continues the location service call flow if the notification type is “privacyOverride”. If the subscriber selects “Allow” on the notification and verification dialog box, the LSA immediately continues the call flow. If the subscriber selects “Deny” on the notification and verification dialog box, the LSA immediately sends a SUPL_END message to the location server with a Status Code of consentDeniedByUser ending the call flow in progress. If the notification type is set to “notificationAndVerficationAllowedNA” and the subscriber does not select “Allow” or “Deny” before the dialog box is removed from the display, the LSA immediately continues with the call flow. If the notification type is set to “notificationAndVerficationDeniedNA” and the subscriber does not select “Allow” or “Deny” before the dialog box is removed from the display, a SUPL_END message is immediately sent to the location server with a Status Code of consentDeniedByUser, ending the call flow in progress.

The SET downloads and installs the LSA package through an appropriate website. Upon successful installation and execution of the LSA agent, the LSA begins the Initial Device Registration process.

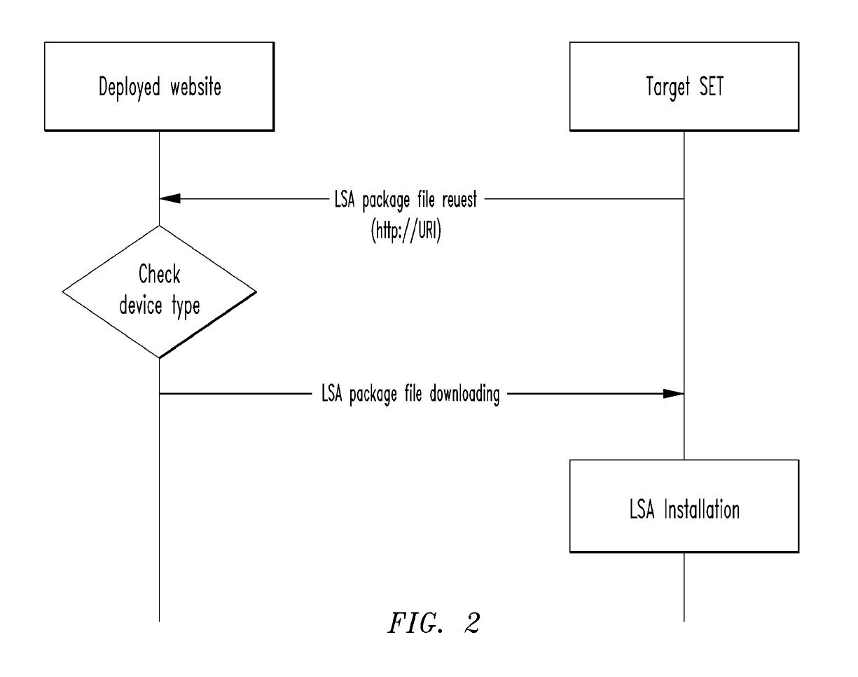

FIG. 2 details an exemplary LSA installation procedure, in accordance with the principles of the present invention.

The LSA provides the ability to upgrade without any user input to the LSA. The LSA supports automatically checking for updates with a location agent management module (LAMM). Upon detection of a newer version of the agent, the LSA initiates over the air (OTA) upgrade procedures.

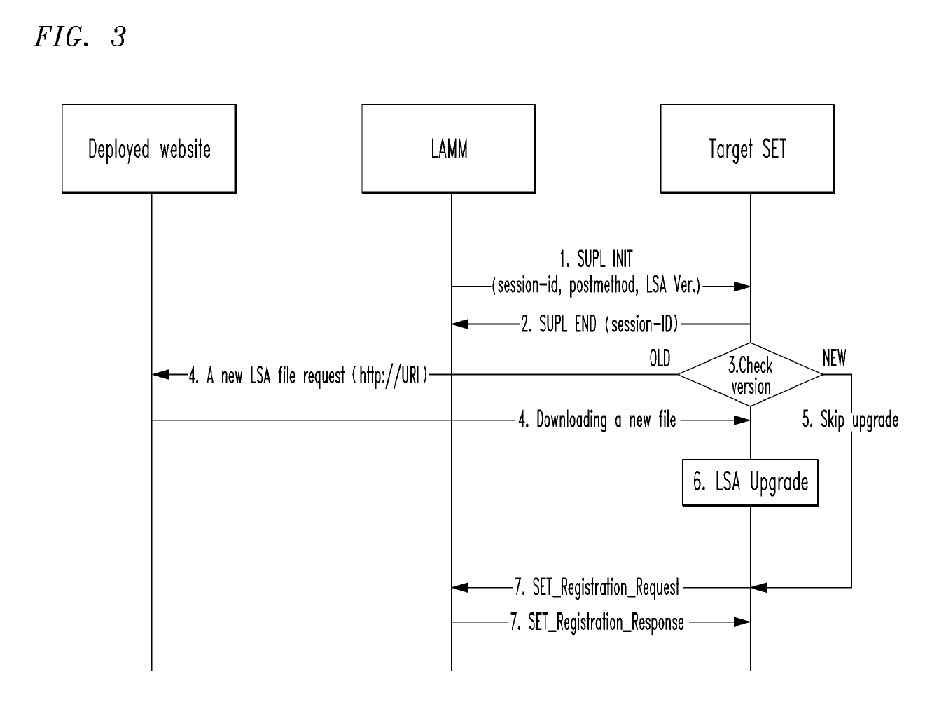

FIG. 3 shows an exemplary upgrade flow, in accordance with the principles of the present invention.

In particular, as shown in step 1 of FIG. 3, The LAMM initiates the location session with the SET using the SUPL INIT message. The SUPL INIT message contains at least session-id, proxy/non-proxy mode indicator, the intended positioning method and LSA version. In step 2, the LSA sends a SUPL END message, and the LSA analyzes the received SUPL INIT. In step 3, the LSA compares an installed version and a received version. In step 4, if the version is different, the LSA downloads a new package file from an appropriate secured website. If the version is the same, in step 5, the LSA sends a SET Registration Request when timer UT3 is expired. In step 6, the LSA starts the upgrade process. In step 7, after the upgrade process is finished, the startup Set Registration procedure may be the same as at installation.

To accomplish initial SET Registration, the LSA registers with the LAMM to let the LAMM know that the LSA has been installed and can receive location requests.

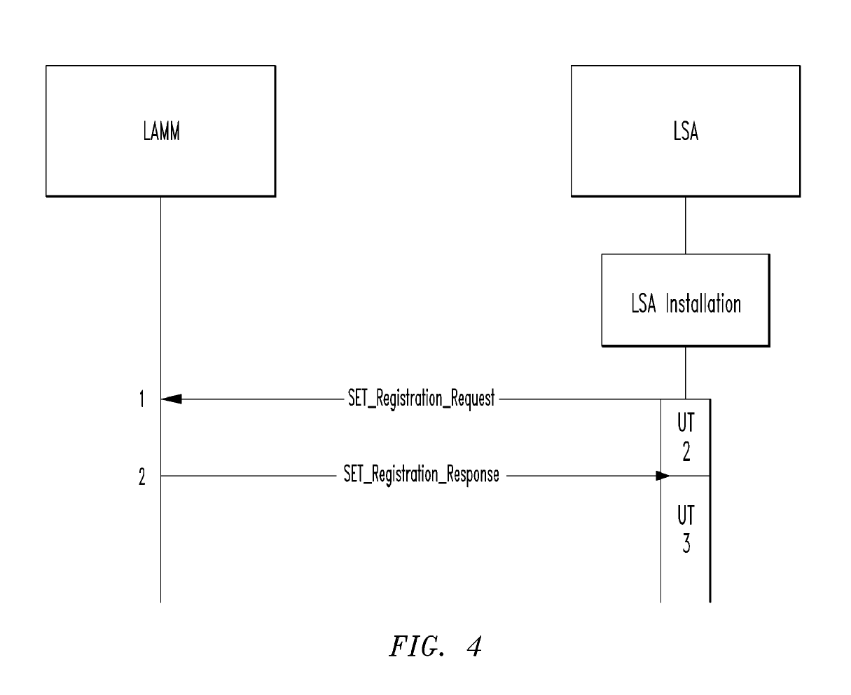

FIG. 4 shows exemplary SET Registration, in accordance with the principles of the present invention.

In particular, as shown in step 1, the LSA sends a SET Registration Request to the LAMM; and the LSA starts timer UT2 after sending the SET Registration Request. In step 2, the LSA receives a SET_Registration_Response; and upon receipt of the SET Registration Response message, the LSA stops timer UT2, and starts timer UT3.

The LSA registers with the LAMM upon agent installation utilizing the SET Registration Request message. The LSA initializes the SET Registration Request parameters: The Positioning Technology Positioning methods are set to those supported by the underlying positioning protocol supported natively by the SET. The Preferred Mode is set to “No Preferred Mode”. All of the Pos Protocol parameters are set to “false”. The Service Capabilities parameters are set to indicate if periodic and/or area event triggers are supported. Constraint parameters may be set for periodic and area event triggers.

The LSA initializes parameters based on the SET Registration Request parameters. If the LSA does not receive a successful acknowledgment in the SET Registration Response from the LAMM, the LSA retries registration based on a configurable amount of wait times, for a configurable amount of attempts. If the LSA does not receive a SET Registration Response after a configurable timer UT2, the LSA retries registration based on a configurable amount of wait times, for a configurable amount of attempts. If the registration procedure is still not successful after the configurable number or attempts, the LSA displays a failed registration dialog box. If the LSA receives a successful acknowledgement from the LAMM, no dialog box is required and the LSA preferably begins to process location requests.

The LSA registers with the LAMM at startup when the mobile device is powered on.

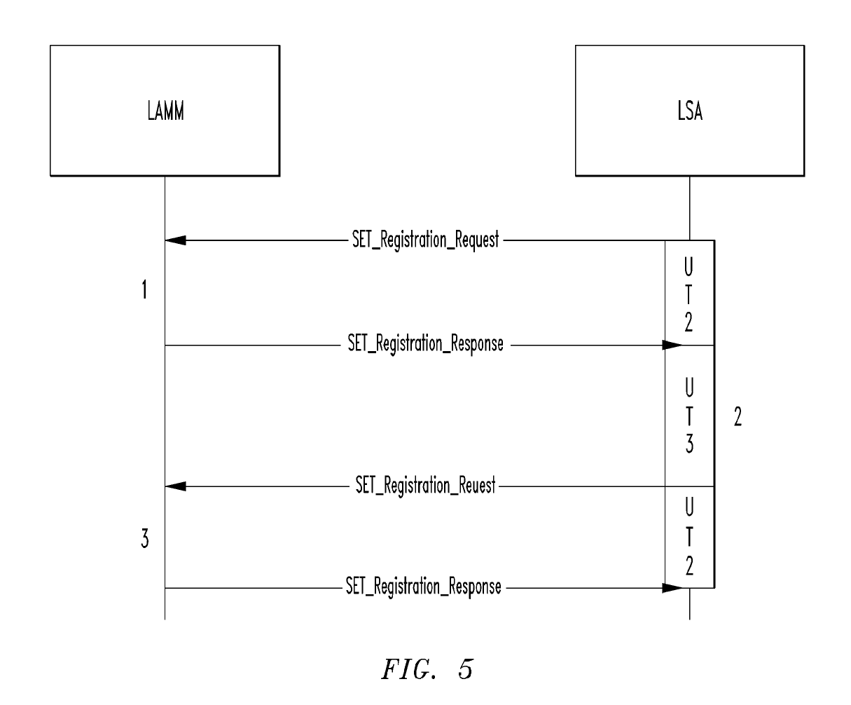

FIG. 5 shows a periodic SET Registration whereby the LSA periodically registers with the LAMM to renew its registration, in accordance with the principles of the present invention.

In particular, as shown in FIG. 5, the LSA sends the SET Registration after an installation, an upgrade, and a restart. In step 1, the LSA sends the SET Registration Request to the LAMM, and timer UT2 is started. The LSA receives the SET_Registration_Response, and the timer UT2 is stopped. In step 2, upon receipt of the SET Registration Response message, the LSA starts timer UT3. In step 3, when timer UT3 expires the configured default value, the LSA sends the SET Registration Request to the LAMM, and timer UT2 is started. The LSA receives the SET_Registration_Response, timer UT2 is stopped, and timer UT3 is started.

There are two variations of dialog box. The notification only dialog box has a single button that only dismisses the dialog. The notification and verification dialog box has two buttons, one to allow the location request to proceed and the other to deny the position from occurring.

Preferably there are no explicit requirements for dialog box size, text justification or layouts, to minimize porting efforts between SETs. In the disclosed embodiments, the LSA supports dialog boxes. The background color of all elements within the dialog box are preferably individually configurable. The foreground color (text) of all elements within the dialog box are individually configurable. The font family and size of all elements within the dialog box are individually configurable. The menu bar supports a configurable title, and adds a configurable icon. The LSA displays a body text box within the dialog box. The body text box optionally includes the application name within the text based on configuration. The body text box text is preferably configurable. The LSA preferably supports a version text box that displays the current version of the LSA agent installed on the SET.

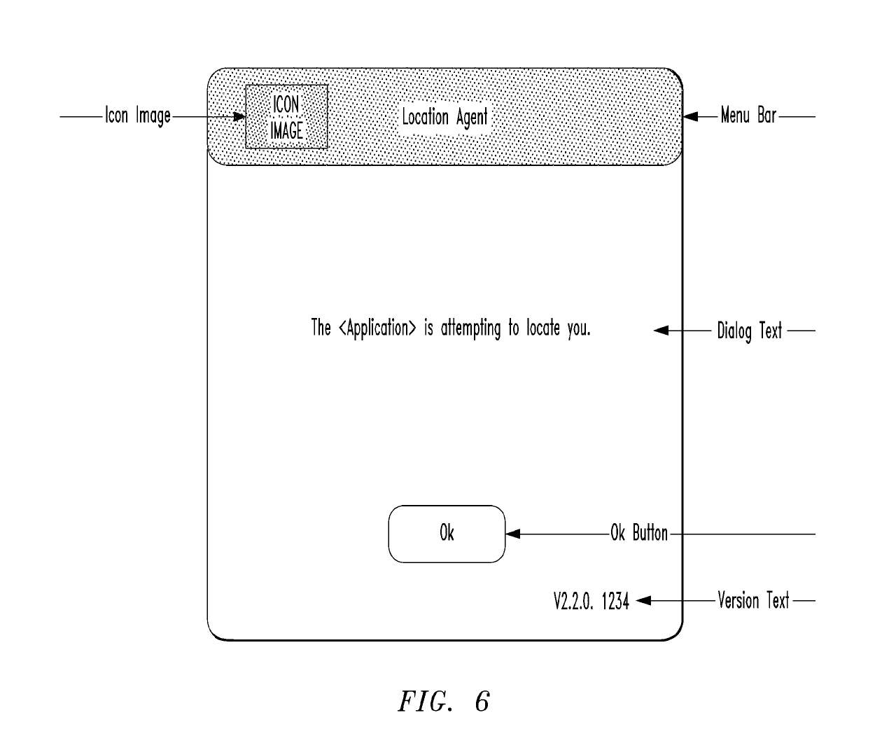

FIG. 6 shows an exemplary Notification Only dialog box for when the received privacy indicates “notification only”, in accordance with the principles of the present invention.

In particular, as shown in FIG. 6, the LSA displays an “Ok” button, the text of which is preferably configurable.

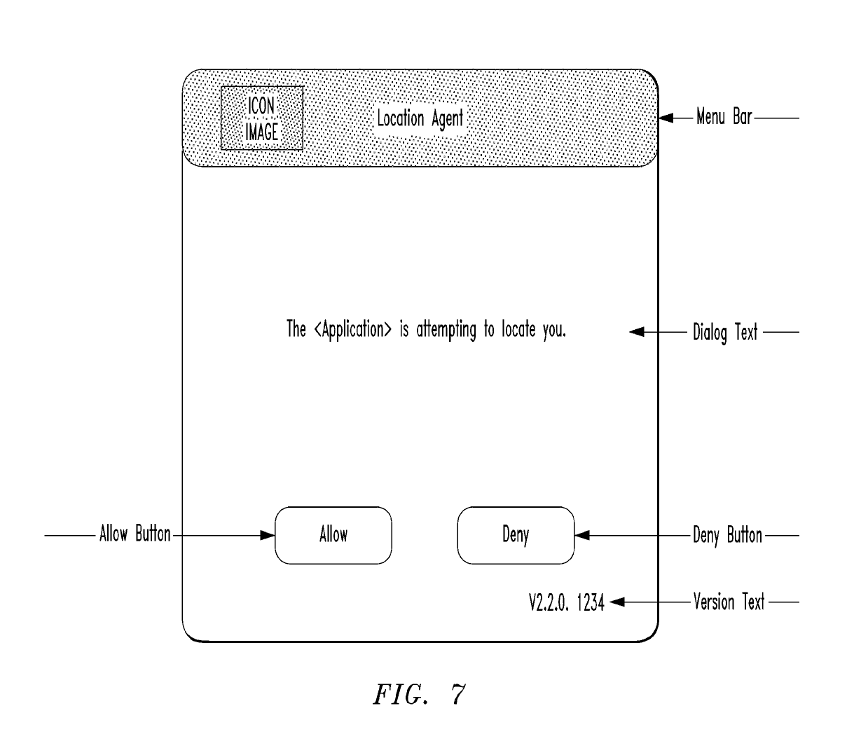

FIG. 7 shows an exemplary Notification and verification dialog box for when the received privacy indicates “notification and verification”, in accordance with the principles of the present invention.

In particular, as shown in FIG. 7, the LSA displays an “Allow” button, the text of which is preferably configurable. The LSA also displays a “Deny” button, the text of which may also be configurable.

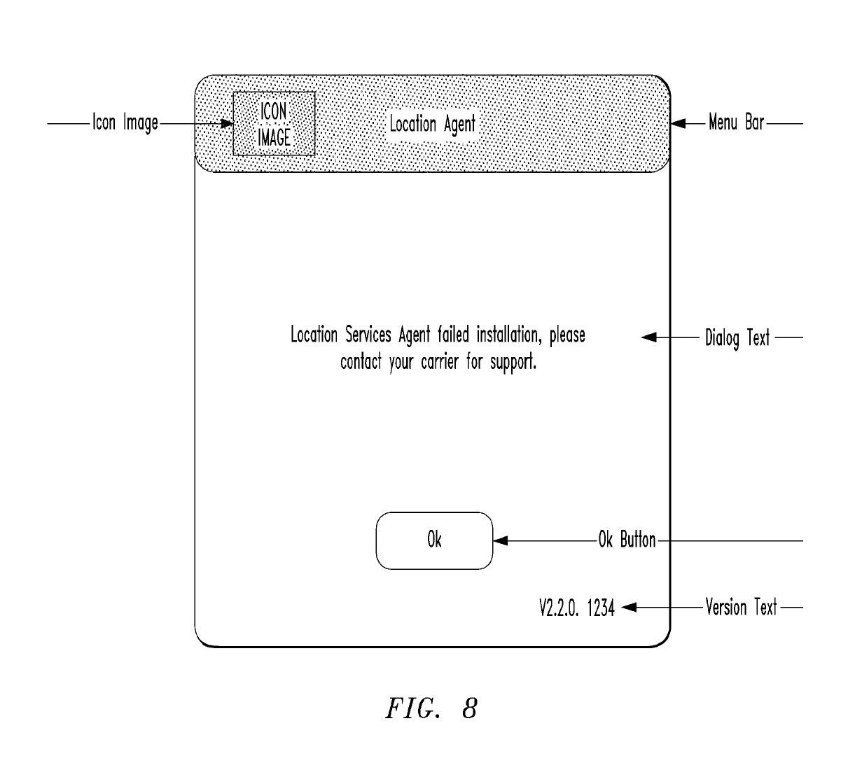

FIG. 8 depicts dialog box requirements when the LSA fails to register with the LAMM, in accordance with the principles of the present invention.

In particular, as shown in FIG. 8, the LSA displays an “Ok” button, and if selected, the dialog box is removed. The text of the “Ok” box is preferably configurable, as is the text of the dialog box. If the user does not select the “Ok” button within a configurable number of seconds, the LSA removes the dialog box after a default time value.

The LSA supports J2ME (Java) enabled devices, and RIM devices.

The LSA supports touch screen devices, and rotating device screens such as in the iPhone™. Landscape mode and portrait mode display are supported.

The LSA supports 32 periodic triggered services, and 32 area event triggers.

Before sending any ULP messages the SET takes needed actions such that a TLS connection exists to the LAMM. This can be achieved by establishing a new connection, resuming a connection, or reusing an existing TLS connection. This includes establishment or utilization of various data connectivity resources that depend on the terminal in which the SET resides, and the type of access network.

The detailed call flows in this section describe when a TLS connection no longer is needed. The TLS connection is then released unless another SUPL session is using the TLS connection.

Scenario 1: <Immediate Location Services>

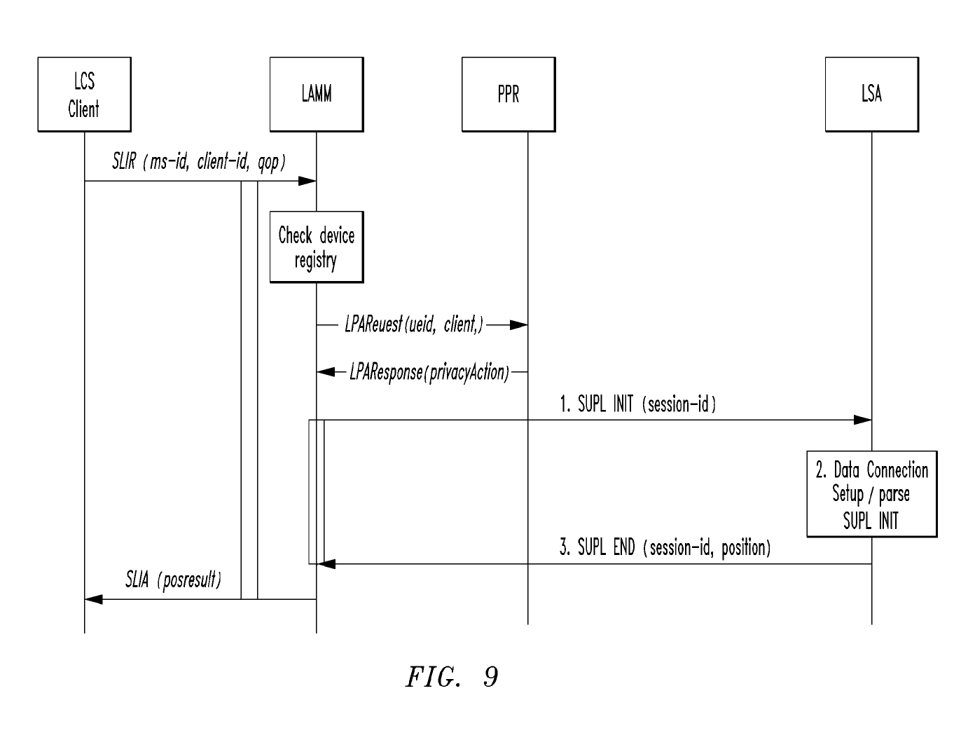

The LAMM undertakes a protocol with the LSA that is simply the SUPL INIT message as a location request. The LSA responds with the SUPL END message containing a position parameter or appropriate error indication. FIG. 9 shows a standard Immediate Service Sequence diagram, in accordance with the principles of the present invention.

In particular, as shown in step 1 of FIG. 9, the LAMM initiates a location session with the LSA using the SUPL INIT message. The LAMM sets a notification parameter in the SUPL INIT based on privacyAction. Note that the LAMM sends the SUPL INIT message through MT Short Message Service (SMS). In step 2, the LSA processes the SUPL INIT message which includes evaluating the notification rules and following the appropriate actions, and then calculates or obtains the requested location. This processing occurs without assistance from the LAMM. The LSA then establishes a secure connection to the LAMM. The LSA may reuse any existing connection to the LAMM if there is one, or resume an earlier connection. In this case, the notification rules in the SUPL INIT indicate normal notification (i.e. noNotificatioNoVerification, notificationOnly, or notificationAndVerification). The LSA displays a dialog box for notificationOnly or notificatioAndVerification rules. In step 3, the LSA sends SUPL END with position or error to the LAMM.

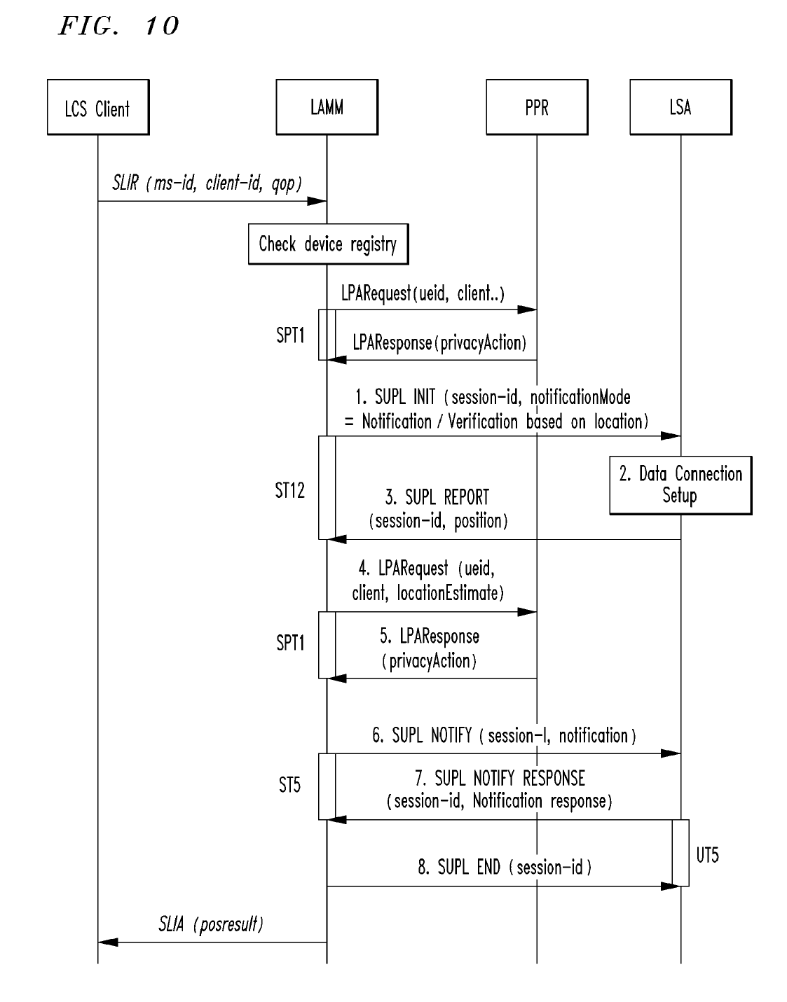

FIG. 10 shows Notification based on current position, in accordance with the principles of the present invention.

In particular, as shown in step 1 of FIG. 10, the LAMM first checks whether additionalLocationCheck is set in the LPAResponse and then checks the privacyAction received from the PPR. In this case, additionalLocationCheck is set in the LPAResponse, which indicates notification based on current location is required. Therefore, The LAMM initiates a location session with the LSA using the SUPL INIT message with notificationMode set to notification/verification based on current location. In step 2, the LSA processes the SUPL INIT message which includes evaluating the notification rules and following the appropriate actions. In this case, since the notification rules in the SUPL INIT indicate notification/verification based on current location, the LSA directly proceeds to calculate or obtain the requested location with notifying the user. The LSA displays a dialog box for notificationAndVerification rule. This processing occurs without assistance from the LAMM. The LSA then establishes a secure connection to the LAMM. The LSA may reuse any existing connection to the LAMM if there is one, or resume an earlier connection. In step 3, the LSA sends a SUPL REPORT with position and VER to the LAMM. If the LSA failed to obtain position, it sends a SUPL END to terminate the immediate session. In step 4, the LAMM verifies that the hash of the SUPL INIT message contained in the VER field matches the MAC value or one of the MAC values it has computed for the session. In case of verification failure, the LAMM drops the position returned and sends an MLP SLIA to the LCS client with proper error code and sends a SUPL END to the LSA. If SUPL INIT verification is successful, the LAMM then authenticates the LSA. If LSA is successfully authenticated, the LAMM sends a PCP LPARequest to the PPR with location estimate. In step 5, the PPR responds with a PCP LPAResponse. In step 6, the LAMM checks the privacyAction received from the PPR. If the privacyAction indicates that the location request is not allowed, the LAMM returns an MLP SLIA with proper error code to the LCS client and sends a SUPL END to the LSA to terminate the location session. If the privacyAction indicates that notification is not required, the LAMM returns an MLP SLIA with position and sends a SUPL END to the LSA to terminate the location session. If the privacyAction indicates notification is required, the LAMM sends a SUPL NOTIFY to the LSA with a notification parameter set according to privacyAction. In step 7, the LSA evaluates the notification rules and follows the appropriate actions. A SUPL NOTIFICATION RESPONSE is sent to the LAMM once user notification and verification is complete. In step 8, the LAMM sends a SUPL END to the LSA to terminate the location session.

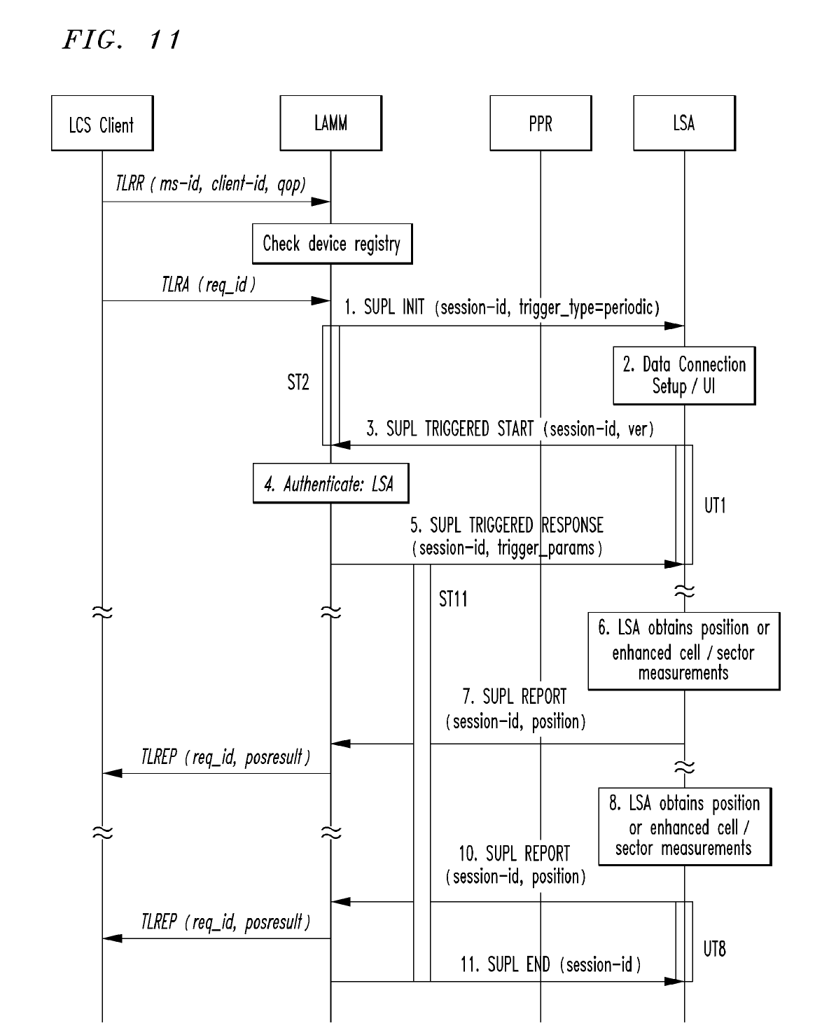

FIG. 11 shows exemplary call flows for a periodically triggered location service, in accordance with the principles of the present invention.

In particular, the call flows shown in FIG. 11 are for MLP periodic triggered services. The periodic trigger mechanism preferably resides in the LSA, which means the LSA periodically performs actions required to determine a position estimate. The LAMM receives those reports in a SUPL Report message, and forwards them to the LCS client.

In step 1 of FIG. 11, if positioning is allowed by subscriber privacy, the LAMM initiates a periodic trigger session with the LSA using the SUPL INIT message. The SUPL INIT message contains at least session-id, trigger type indicator (in this case periodic). If the result of the privacy check indicates that notification or verification to the target subscriber is needed, the XSS also includes the Notification element in the SUPL INIT message. Before the SUPL INIT message is sent, the LAMM also computes and stores a hash of the message.

In step 2, the LSA calculates and saves the relative time to absolute time after it receives the SUPL INIT. The LSA evaluates the Notification rules and follows the appropriate actions. The LSA displays a dialog box if the Notification rule has a parameter. The LSA then establishes a secure connection to the LAMM. The LSA may reuse any existing connection to the LAMM if there is one, or resume an earlier connection.

In step 3, the LSA sends the SUPL TRIGGERED START message to start a periodic triggered session with the LAMM. The SUPL TRIGGERED START message contains at least session-id, and a hash of the received SUPL INIT message (ver). The LSA starts timer UT1 after sending the SUPL TRIGGERED START.

In step 4, the LAMM verifies that the hash of the SUPL INIT message contained in the VER field matches the MAC value or one of the MAC values it has computed for the session. In the case of verification failure, the LAMM terminates the triggered session and sends SUPL END to the LSA and MLP TLREP to the LCS Client with a proper error code. If SUPL INIT verification is successful, the LAMM authenticates the LSA.

In step 5, if the LSA is successfully authenticated, the LAMM sends the SUPL TRIGGERED RESPONSE message including session-id and periodic trigger parameters to the LSA. If LSA authentication fails, the LAMM terminates the triggered session and sends SUPL END to the SET and MLP TLREP to the LCS Client with a proper error code.

In step 6, upon receipt of the SUPL TRIGGERED RESPONSE message, the LSA stops timer UT1. When the periodic trigger in the LSA indicates that a position fix has to be performed, the LSA obtains current location of the mobile device by calling the location API provided by the mobile device. The exact location protocol used by the mobile device to retrieve its position is transparent to the LSA and LAMM, but it may be one of the protocols such as SUPL, CDMA V1, CDMA V2, etc.

In step 7, once the mobile device location result is obtained, the LSA sends the SUPL REPORT with position or error code to the LAMM.

In step 8, based on information received in the SUPL REPORT, the LAMM reports mobile device position or error to the LCS client.

Steps 8-9 are repeated for each interval. At the start of the last interval, the LSA obtains a current location of the mobile device as it does in step 8.

In step 10, the LSA starts timer UT8 after sending a last SUPL_REPORT.

In step 11, since this is the last report, the LAMM sends the SUPL END message to the LSA, and ends the triggered session.

In step 12, upon receipt of the SUPL_END message, the LSA stops timer UT8. If timer UT8 expires before the SUPL_END report is received, the LSA ends the session and releases all resources allocated for the session.

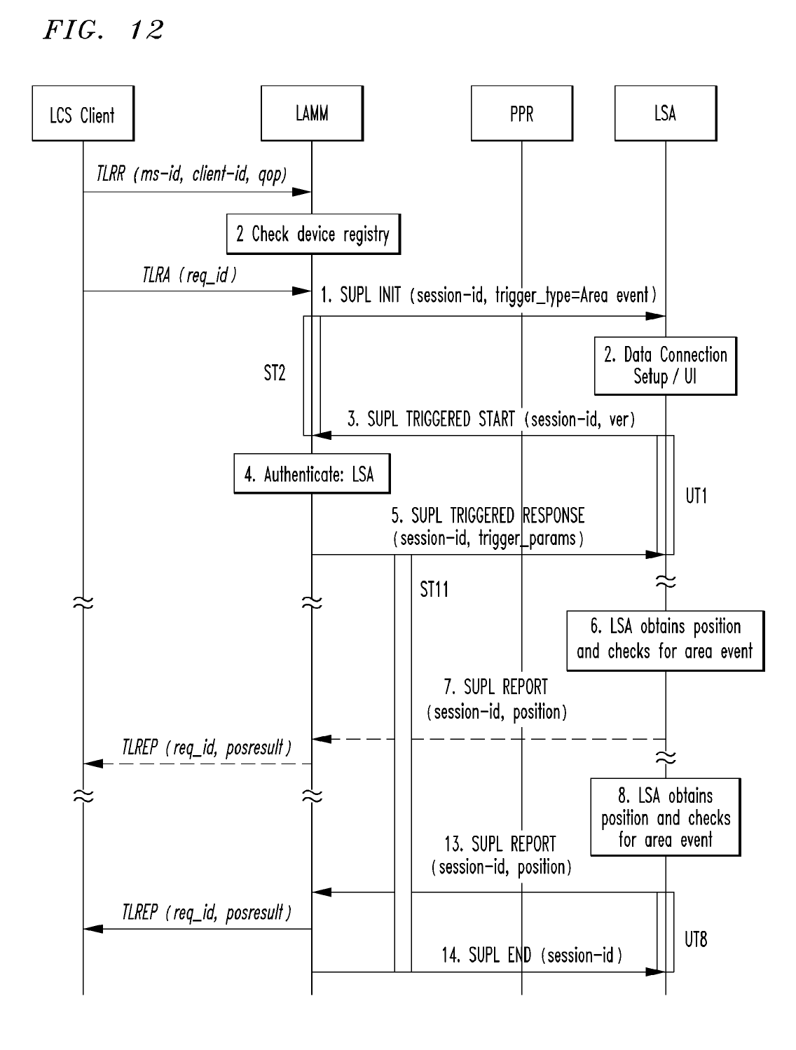

FIG. 12 shows call flows for area event triggered services, in accordance with the principles of the present invention.

In particular, the trigger resides in the LSA and the LSA makes the decision if an area event occurred based on continuously repeated position determinations. In step 1, if positioning is allowed by subscriber privacy, the LAMM initiates a periodic trigger session with the LSA using the SUPL INIT message. The SUPL INIT message contains at least session-id, and trigger type indicator (in this case area event). If the result of the privacy check indicates that notification or verification to the target subscriber is needed, the XSS also includes the Notification element in the SUPL INIT message. Before the SUPL INIT message is sent, the LAMM also computes and stores a hash of the message. The SUPL INIT may be sent to the LSA using a transport supported by the mobile device.

In step 2, the LSA evaluates the Notification rules and follows the appropriate actions. The LSA displays a dialog box if the Notification rule has a parameter. The LSA then establishes a secure connection to the LAMM. The LSA may reuse any existing connection to the LAMM if there is one, or resume an earlier connection.

In step 3, the LSA sends a SUPL TRIGGERED START message to start an area event triggered session with the LAMM. The SUPL TRIGGERED START message contains at least session-id, and a hash of the received SUPL INIT message (ver). The LSA starts timer UT1 after sending a SUPL TRIGGERED START.

In step 4, the LAMM verifies that the hash of the SUPL INIT message contained in the VER field matches the MAC value or one of the MAC values it has computed for the session. In case of verification failure, the LAMM terminates the triggered session and sends SUPL END to the LSA and MLP TLREP to the LCS client with a proper error code. If SUPL INIT verification is successful, the LAMM authenticates the LSA.

In step 5, if the LSA is successfully authenticated, the LAMM sends a SUPL TRIGGERED RESPONSE message including session-id and area event trigger parameters to the LSA. If LSA authentication fails, the LAMM terminates the triggered session and sends SUPL END to the LSA and MLP TLREP to the LCS Client with a proper error code.

In step 6, upon receipt of the SUPL TRIGGERED RESPONSE message, the LSA stops timer UT1. When the area event trigger mechanism in the LSA indicates that a position fix is to be executed, the LSA obtains a current location of the mobile device using the location API provided by the mobile device. The LSA then checks whether the area event has occurred or not.

In step 7, if the LSA detects occurrence of an area event, it sends a SUPL REPORT to the LAMM; otherwise, step 6 is repeated.

In step 8, upon receipt of SUPL REPORT from the LSA, the LAMM reports the occurrence of area event to the LCS client by sending a TLREP to the LCS client.

Steps 7-8 are repeated until a last report is generated.

After the list report is generated, the LSA starts timer UT8 after sending a last SUPL_REPORT. Since this is the last report, the LAMM sends a SUPL END message to the LSA and ends the triggered session. If timer UT8 expires before the SUPL END report is received, the LSA ends the session and releases all resources allocated for the session.

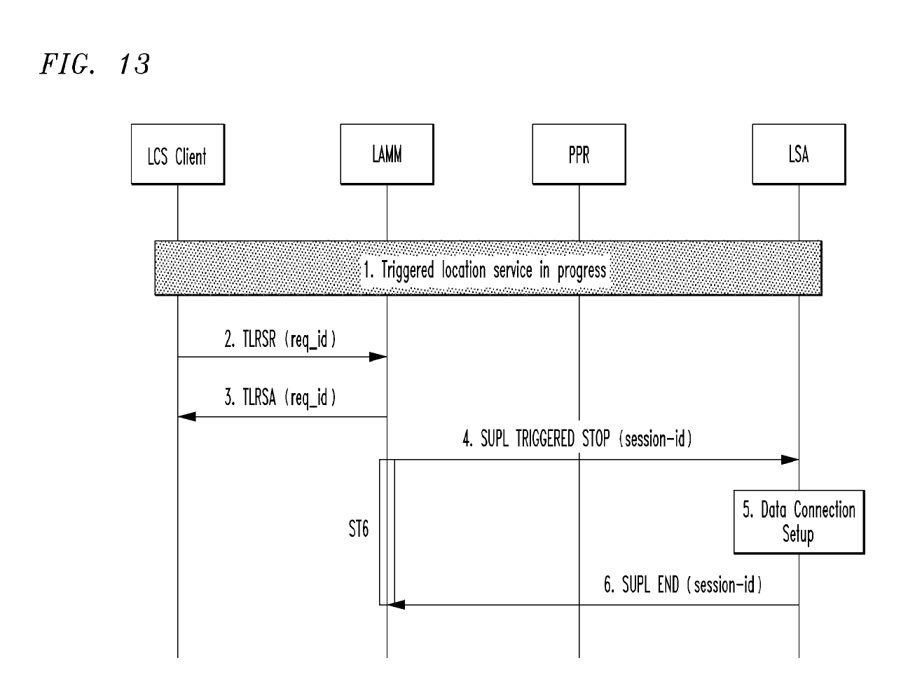

FIG. 13 shows an exemplary LCS client triggered service cancellation procedure, in accordance with the principles of the present invention.

In particular, as shown in step 1 of FIG. 13, a triggered location session is in progress. In step 2, the LCS Client requests cancellation of the triggered location session by sending an MLP TLRSR message to the LAMM. The LAMM responds in step 3 with an MLP TLRSA. In step 4, the LAMM sends a SUPL TRIGGERED STOP to the LSA. In step 5, upon receipt of the SUPL TRIGGERED STOP message, the LSA establishes a secure connection to the LAMM. The LSA may reuse any existing connection to the LAMM, if there is one, or resume an earlier connection. In step 6, the LSA sends a SUPL END message to the LAMM to confirm the cancellation of the triggered session. The SUPL END message contains session-id. The LAMM terminates the triggered session on receipt of the SUPL END. In step 7, the LAMM sends an MLP TLRSA to the LCS Client confirming cancellation of the triggered session.

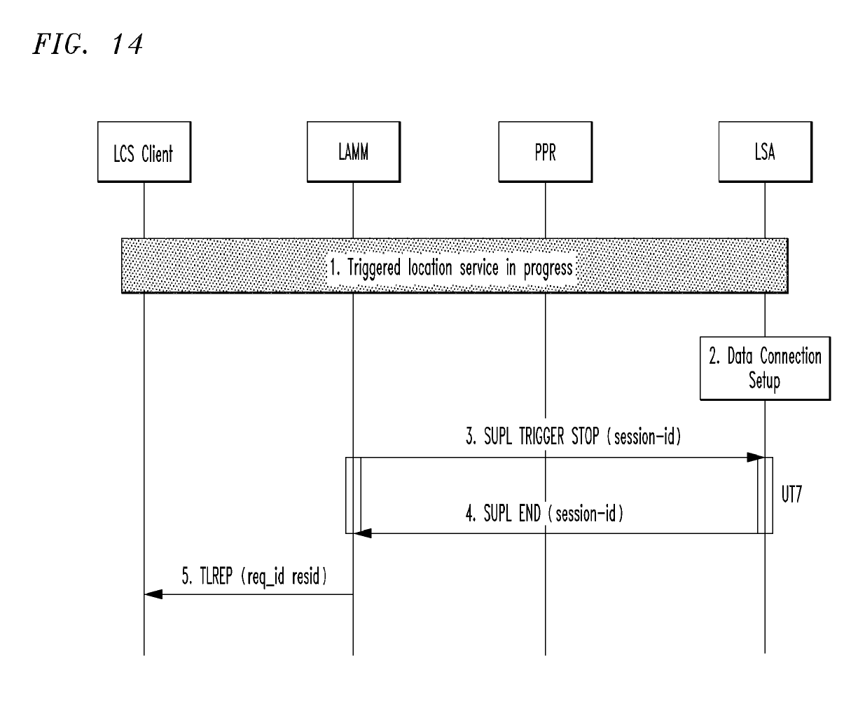

FIG. 14 shows exemplary call flow for the location services agent (LSA) canceling triggered service, in accordance with the principles of the present invention.

In particular, as shown in step 1 of FIG. 14, a triggered location session is in progress. In step 2, the LSA determines that the ongoing triggered session needs to be canceled. The LSA then establishes a secure connection to the LAMM. The LSA may reuse any existing connection to the LAMM, if there is one, or resume an earlier connection. In step 3, the LSA starts timer UT7 after sending. In step 4, upon receipt of the SUPL TRIGGERED STOP message, the LAMM sends a SUPL END to the LSA. In step 5, the LAMM then sends an MLP TLRSA to the LCS client to cancel the triggered session with the LCS Client. In step 6, upon receipt of the SUPL_END message, the LSA stops timer UT7.

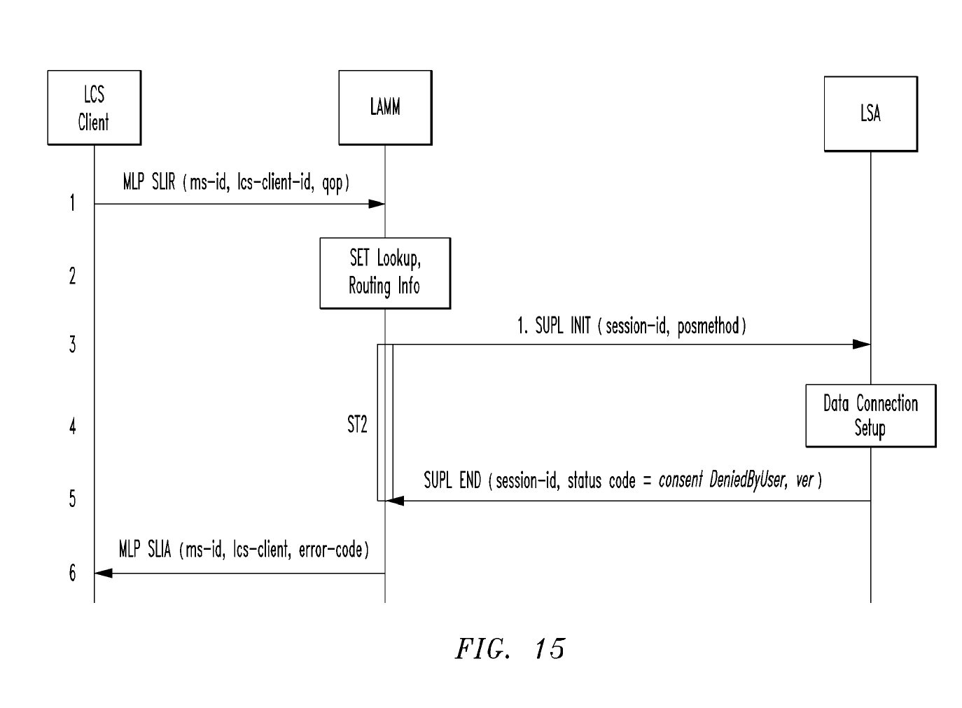

FIG. 15 shows exemplary immediate location request exception procedures for user denied positioning, in accordance with the principles of the present invention.

In particular, as shown in FIG. 15, after receiving a SUPL INIT message the LSA executes the notification/verification procedure. In this scenario, the subscriber rejects the location request.

In step 1, an LCS Client sends an MLP SLIR message to the LAMM, with which the LSA is associated. The LAMM authenticates the LSA and checks if the LSA is authorized for the service it requested, based on the client-id received. Further, based on the received ms-id, the LAMM applies subscriber privacy against the client-id. In step 2, the LAMM verifies that the LSA is currently not SUPL roaming. The LAMM may also verify that the LSA supports SUPL. In step 3, the LAMM initiates the location session with the LSA using a SUPL INIT message. The SUPL INIT message contains at least session-id. In this case the result of the privacy check in step 1 indicated that notification or verification to the target subscriber is needed, and the LAMM therefore includes the Notification element in the SUPL INIT message. In step 4, the LSA analyzes the received SUPL INIT. If found to be non authentic, the LSA takes no further actions. Otherwise, the LSA takes needed action preparing for establishment or resumption of a secure connection. In step 5, the LSA establishes a secure connection to the LAMM. The LSA evaluates the notification rules and displays a dialog box to the subscriber of the position requested. In this case the user rejects the location request, either by explicit action or implicitly by not responding to the notification, and the LSA returns to the LAMM the SUPL END message containing the session-id, a hash of the received SUPL INIT message (ver) and the status code consentDeniedByUser. In step 6, the LAMM sends the position response, containing the ms-id, client-id, and an appropriate error-code back to the LSA using an MLP SLIA message.

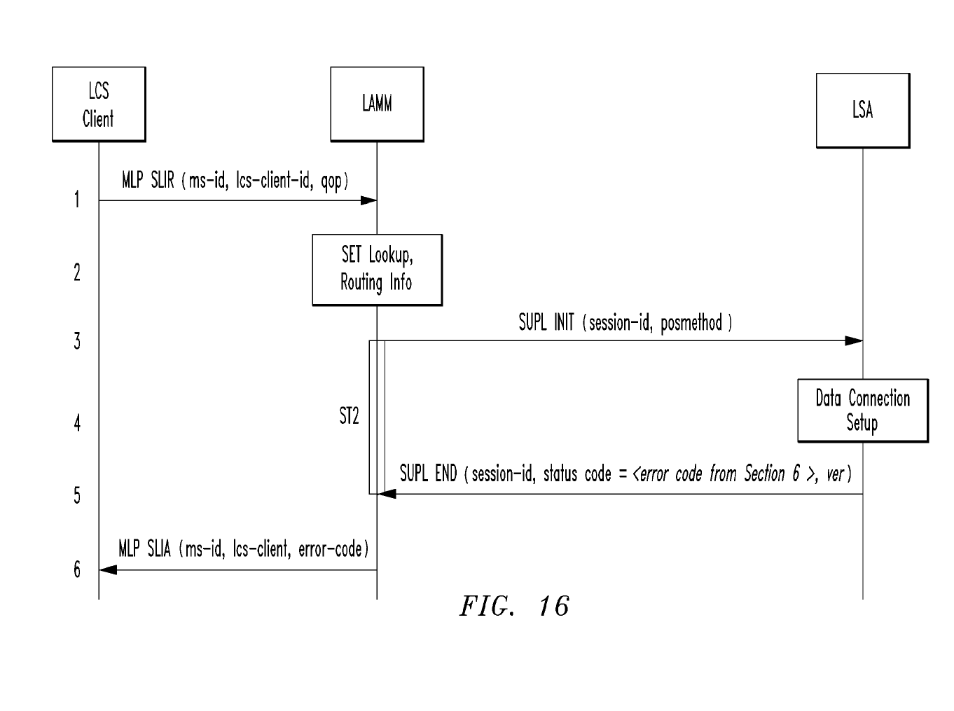

FIG. 16 shows exemplary call flow for general error processing of an immediate location request exception procedure, in accordance with the principles of the present invention.

In particular, as shown in FIG. 16, after receipt of a SUPL INIT message, the LSA encounters an error. The LSA returns the appropriate error code. A position is preferably only returned if a valid position was calculated by the LSA.

In step 1, the LCS Client sends an MLP SLIR message to the LAMM, with which the LSA is associated. The LAMM authenticates the LSA and checks if the LSA is authorized for the service it requested, based on the client-id received. Further, based on the received ms-id, the LAMM applies subscriber privacy against the client-id. In step 2, the LAMM verifies that the LSA is currently not SUPL roaming. The LAMM may also verify that the LSA supports SUPL. In step 3, the LAMM initiates the location session with the LSA using the SUPL INIT message. The SUPL INIT message contains at least session-id. In this case the result of the privacy check in step 1 indicated that notification or verification to the target subscriber is needed, and the LAMM therefore includes the Notification element in the SUPL INIT message. In step 4, the LSA analyzes the received SUPL INIT. If found to be non-authentic the LSA takes no further action. Otherwise the LSA takes needed action preparing for establishment or resumption of a secure connection. In step 5, the LSA encounters an error. The LSA establishes a secure connection to the LAMM. The LSA returns to the LAMM the SUPL END message containing the session-id, a hash of the received SUPL INIT message (ver) and the appropriate status code for the error detected by the LSA. The LSA only returns a position if a valid position was calculated by the LSA. In step 6, the LAMM sends a position response, containing the ms-id, client-id, and an appropriate error-code back to the LSA using an MLP SLIA message.

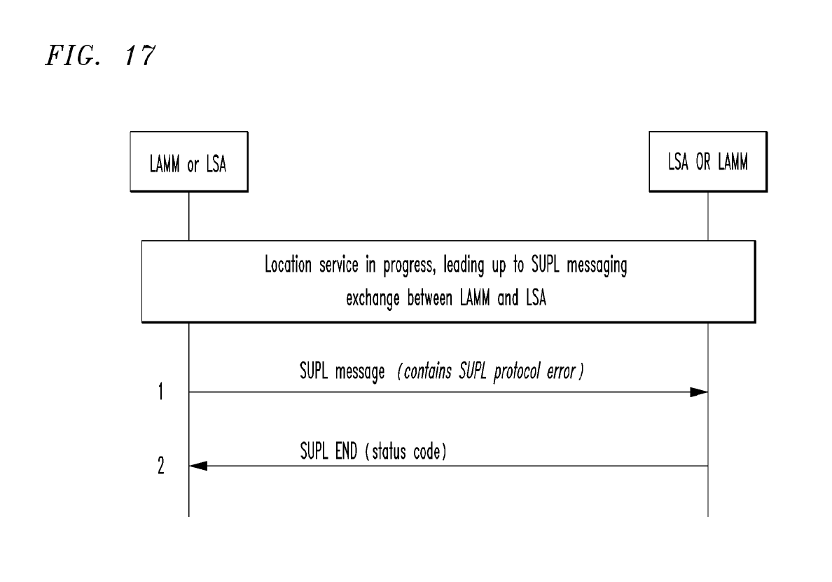

FIG. 17 shows an error SUPL protocol error, in accordance with the principles of the present invention.

In particular, as shown in FIG. 17, when during a SUPL session either the LSA or the LAMM receives a message, which cannot be processed by the receiving entity due to SUPL protocol error, the receiving entity sends a SUPL END message to the sending entity including a status code indicating protocol error. Possible protocol error cases can be, e.g.:
mandatory and/or conditional parameter is missing
wrong parameter value
unexpected message
invalid session-id
positioning protocol mismatch

The SUPL END message includes the valid session-id actually being used in the session. When an invalid session-id has been received, the invalid session-id is returned to the sending entity along with the status code. A received session-id is treated as invalid if no open session can be assigned to this session-id, or, in the case of the SUPL INIT message, the session-id is not treated as LAMM-generated by the LSA. Afterwards, the LAMM and the LSA release the resources related to this session at the Lup interface.

The described processing for protocol error preferably applies only to messages on the SUPL level. Exceptions, which occur during application of the specific positioning protocols (e.g., RRLP, RRC, TIA-801 or LPP) are handled by the exception procedure specific for this positioning protocol along with related messages.

The following SUPL protocol error types, attributable to either the LAMM or the LSA, are addressed by the general exception procedure shown in FIG. 17:
Missing mandatory parameter(s)
Wrong parameter value
Unexpected message
Positioning protocol mismatch

In step 1 of FIG. 17, a SUPL message sent from either the LAMM or the LSA contains a protocol error. Such message, if sent by the LAMM, may be SUPL_TRIGGERED_RESPONSE; such message, if sent by the LSA, may be SUPL_TRIGGERED_START or SUPL REPORT. In step 2, the recipient (either the LSA or LAMM) of the SUPL message containing the protocol error responds with a SUPL END message containing the status code for the specific protocol error. Afterwards, both sides release all resources related to this session at the Lup reference point.

The timers and events used by the LSA are summarized below. The exemplary default timer values may be adjusted to optimize operation for a specific network implementation.

Timer UT1 (default 11 sec): For immediate applications, from sending of SUPL START to receipt of SUPL RESPONSE or SUPL END. In trigger positioning, from sending of SUPL TRIGGERED START to receipt of SUPL TRIGGERED RESPONSE or SUPL END. Upon expiration, the LSA sends SUPL END to the SLP. The LSA clears all session resources at the LSA.

Timer UT2 (default 11 sec): From sending of SET Registration Request to receipt of SET Response message. Upon expiration, retry defined time (sec.) and numbers on the configuration file.

Timer UT3 (default 43200 sec): For periodic set registration scenario. From receipt of SET Registration response to sending of SET Registration Request. Upon expiration, the LSA sends SET Registration request to the LAMM.

Timer UT5 (default 10 sec): Only applicable to “notification based on location” scenarios. From sending of SUPL NOTIFY RESPONSE to receipt of SUPL END. Upon expiration, the LSA sends SUPL END to the LAMM. The LSA clears all session resources.

Timer UT7 (default 10 sec): Only applicable to triggered scenarios. From sending of SUPL TRIGGERED STOP to receipt of SUPL END. Upon expiration, the LSA sends SUPL END to the LAMM. The LSA clears all session resources.

Timer UT8 (default 10 sec): Only applicable to triggered periodic scenarios. From sending the last SUPL REPORT message to receipt of SUPL END. Upon expiration, the LSA sends SUPL END to the LAMM. The LSA clears all session resources.

The LSA preferably supports an upper layer protocol (ULP) with ASN.1 BASIC-PER, unaligned encoding. Preferably all messages defined in the ULP contain a common part and a message specific part.

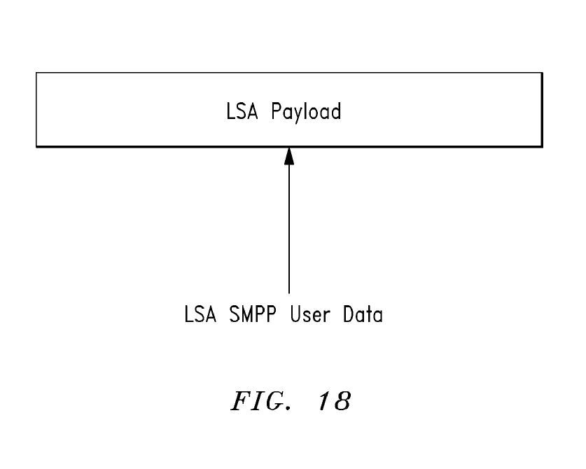

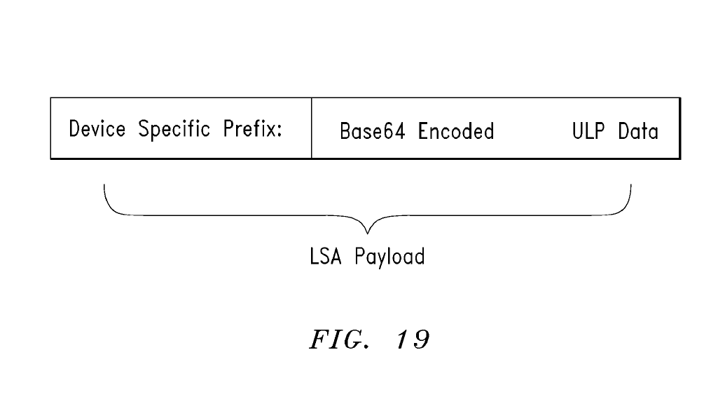

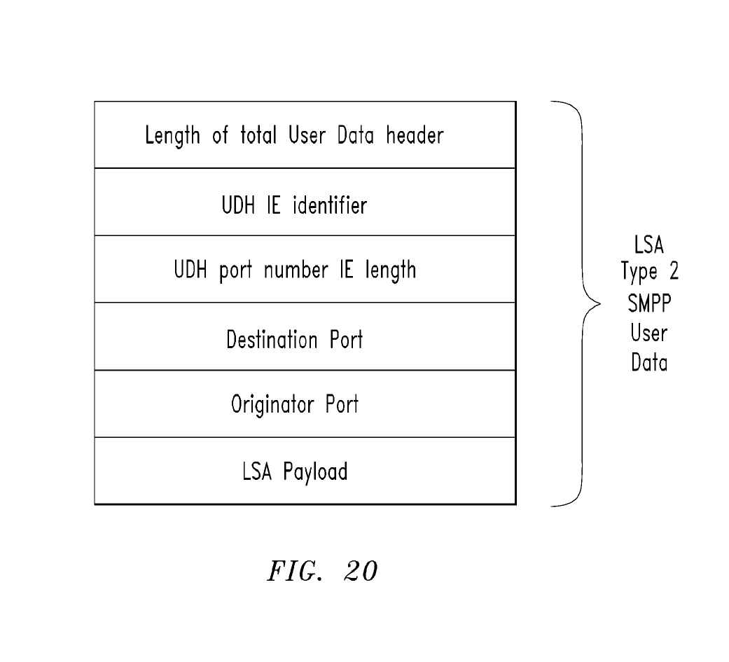

The LSA receives SUPL INIT or SUPL TRIGGER STOP from the LAMM using MT SMS. The LSA preferably supports SMPP[7] with the following clarifications: Depending on the device model, the LSA receives the SMPP SUBMIT_SM message using one of the following options: The LSA SMPP type 1: supports receiving ULS data in MIME MT SMS with a predefined prefix. The LSA type 1 SMPP user data preferably takes the form shown in FIG. 18 depicting the LSA SMPP User Data, and in FIG. 19 showing the LSA payload, in accordance with the principles of the present invention.

Where Base64 encoded ULP Data represents PER encoded SUPL INIT/SUPL TRIGGER STOP message. The type 1 SMPP user data is received from the LAMM as a regular MINE MT SMS and the type 1 SMPP user data included in the short_message field in a SMPP SUBMIT_SM message. The LSA SMPP type 2-supports receipt of ULP data in WDP/UDH datagram. The type 2 SMPP user data is constructed as shown in FIG. 20. Note that the LAMM uses the WDP datagram header without SAR. The LSA payload is defined in FIG. 20 showing LSA type 2 SMPP user data. The type 2 SMPP user data is included in the short_message field in SMPP SUBMIT_SM message. The UDHI Indicator is set in an esm_class field in SMPP SUBMIT_SM to indicate that the User Data Header is used. The destination port in the SMPP User data is configurable according to the target device model.

With respect to transport for other SUPL messages, the transport protocol for all other SUPL messages is preferably TCP/IP with TLS 1.0. The LSA is connected to a LAMM listener port, and preferably supports a configurable port number (with a default of 7299).

The common part preferably contains parameters that are present in all ULP messages.

“Message length” is the length of the entire ULP message in octets. (Note: The first two octets of a PER encoded ULP message contains the length of the entire message. These octets are set to the Message Length when the PER encoding is complete and the entire message length is known.)

“Version” is the version of the ULP protocol, in the form major, minor, service indicator.

“Session ID” is the unique Session ID.

The “Message Payload” parameter preferably contains one of the following messages defined in ULP: SUPL INIT; SUPL END; SUPL TRIGGERED START; SUPL TRIGGERED RESPONSE; SUPL TRIGGERED STOP; SUPL REPORT; SET REGISTRATION REQUEST; and SET REGISTRATION RESPONSE.

SUPL INIT is an initial message from the LAMM to the LSA in Network initiated cases. Positioning method parameter of SUPL INIT defines the positioning technology desired by the LAMM for the SUPL session, e.g., A-GNSS SET Assisted only; A-GNSS SET Based only; A-GNSS SET Assisted preferred (A-GANSS SET Based is a fallback mode); A-GNSS SET Based preferred (A-GANSS SET Assisted is the fallback mode); Autonomous GPS; Autonomous GNSS; AFLT; Enhanced Cell/sector; EOTD; OTDOA; No position. The positioning technology is set to “A-GNSS SET Assisted preferred” by the LAMM. Optional parameters include Notification, Quality of Position (Qop), Notification Mode, Trigger Type, Minimum Major Version, and LSA Version. Regarding Notification, when Notification Mode is Normal Notification/Verification, this field is used to provide instructions to the LSA with respect to notification and privacy. If this field is not present in the LSA, the request is interpreted as type “No notification & no verification”. When Notification Mode is Notification/Verification based on location, this field is not used by the LAMM and the LSA. Notification based on location may be supported, though it is not in the present embodiment. A Notification Mode parameter is not included by the LAMM, normal notification being assumed. The Trigger type parameter indicates a network initiated service type such as Periodic, and Area event. This parameter is conditional and only used if a triggered session is requested in the SUPL INIT message. The Minimum Major Version parameter optionally defines the minimum major version supported by the LAMM which is compatible with the requested service. This parameter may be optional. If not present, the only version compatible with the requested service is the version parameter. The minimum major version must always be smaller than the major version. A suggested range is 0 to 255. The LSA Version parameter defines the latest LSA version available for the device to download.

SUPL END is a message that ends the SUPL procedure, normally or abnormally. A position parameter defines the position result of the LSA. A Status Code parameter defines the status of the message as either an error indication or an information indication. Error indications have values between 0 and 99, information indications having values between 100 and 199. A Ver parameter contains a hash of the SUPL INIT message and is calculated by the SET. This parameter must be present in situations where the SUPL END message is sent as a direct response to SUPL INIT (both proxy and non-proxy mode). HMAC-SHA1-64 may be used as the hash function. The output of the HMAC-SHA1-64 HASH function may be truncated to 64 bits.

SUPL TRIGGERED START is an initial message from the LSA to the LAMM for establishing a triggered session. This parameter contains a hash of the SUPL INIT message. In Network initiated proxy mode, a SET calculates a hash of a received SUPL INIT and includes the result of the hash in this parameter. This parameter is not included in a SUPL TRIGGERED START sent to request new trigger parameters. HMAC-SHA1-64 may be used as the hash function. The output of the HMAC-SHA1-64 HASH function may be truncated to 64 bits.

SUPL TRIGGERED RESPONSE is a response to a SUPL TRIGGERED START message from the LAMM to the LSA. A Trigger Params parameter indicates parameters of a trigger session. For a network initiated trigger service, this parameter must be present. This parameter may be of the Periodic Params or Area Event Params types.

SUPL TRIGGERED STOP is used by the LAMM or the LSA to cancel a triggered session. A Status Code parameter defines the status code of the message.

SUPL REPORT message is used in triggered applications to send one or more position result(s) (calculated by the LSA) and/or enhanced cell/sector measurement(s) from the LSA to the LAMM. The SUPL REPORT message may be used without a position result to indicate to the LAMM that an Area Event has occurred. A result code may optionally be sent to indicate an error condition (e.g. no position available). Note: For uplink reporting, if the amount of report data to be sent exceeds the maximum ULP message length (64K Octets), the LSA sends the report data in multiple SUPL REPORT messages. A ReportDataList optional parameter comprises 1 up to 1024 occurrences of Report Data. A >Report Data parameter contains the actual data to be reported: Position Data, Measurement Data, Result Code, and Time Stamp. A >>Position Data optional parameter is a calculated position and the respective positioning mode used. A >>>position parameter is the calculated position of the X (including a time stamp). A >>>posmethod optional parameter is a positioning method with which the position was calculated (e.g., SET Based A-GPS, autonomous GPS, etc.) This parameter is returned from Location Determination. A >>Result Code optional parameter describes why no position or measurement could be reported: out of radio coverage, no position, no measurement, no position and no measurement, out of memory, out of memory intermediate reporting, and other. A >>Time Stamp optional parameter is a time stamp in absolute time (UTC Time). This parameter is only used if Position Data is not present. If Position Data is present, the timestamp parameter within position is used as timestamp.

SET REGISTRATION REQUEST. The SET Registration Request is sent from the LSA to the LAMM to register that the LSA has been installed or started on a SET. Device identity is contained in the SessionID (SETId) information defined in the common part. An Agent Version parameter is the version of the agent installed. A >maj parameter is a major version, in the range 0 to 255. A >min parameter is a minor version, in the range 0 to 255. A >servind parameter is a service indicator, in the range 0 to 255. A >build parameter is an application build version, in the range 0 to 255. A SET Capabilities parameter defines the set capabilities supported by the SET. A >SET Manufacturer optional parameter indicates the device manufacturer (e.g., Samsung, LG, HTC, etc.) A >SET Type optional parameter is the device model name (e.g., SPH-M330, LX290, etc.) A >SET Version optional parameter is the device version. A >SET OS optional parameter is the device operating system (OS), e.g., RIM, Android, Windows Mobile, Windows CE, Windows Desktop, Symbian, Linux, Palm OS, iOS—(iPhone OS). A Positioning Layer Technology optional parameter indicates the position technology, e.g., BREW, J2ME, QualComm TCP Wrapper CDMA v1, QualCommTCP Wrapper CDMA v2, RIM, SUPLv1.0, SUPLv2.0, ULP, Windows Mobile. A Supported Network Information optional parameter defines parameter defines the type(s) of Network Measurement information which the SET is allowed to send as part of Location ID and Multiple Location IDs. If not present, the SET MAY send any Network Measurement information it supports and has available. This parameter can be of the type GSM, WCDMA, CDMA, WLAN, supportedWLANInfo, supportedWLANApsList, hRDP, UMB, LTE, WIMAX, historic, nonServing, uTRANGPSReferenceTime, uTRANGANSSReferenceTime. Note: GSM, WCDMA and CDMA types to supported location determination supported on SET. Other types always to false. A Registration Expiration Interval optional parameter defines the validity duration of the registration in seconds (Default: UT3 timer value). When not present, 17 hours is assumed by the LAMM. A Triggered SessioniD List optional parameter is a list of triggered sessions that are active in the LSA. When not present, the LAMM assumes no triggered session exists in the LSA.

SET REGISTRATION RESPONSE is sent from the LAMM to the LSA to acknowledge it received the registration request. A Status Code parameter indicates any one of a plurality of suitable status codes.

This section contains descriptions of exemplary parameters used in Upper Level Protocol (ULP) messages.

Velocity describes the velocity of the SET. One of the following four formats are preferably supported: (1) Horizontal Velocity (Bearing, Horizontal speed); (2) Horizontal and Vertical Velocity (Vertical Direction, Bearing, Horizontal speed, Vertical speed); (3) Horizontal Velocity Uncertainty (Bearing, Horizontal speed, Horizontal speed uncertainty); and (4) Horizontal and Vertical Velocity Uncertainty (Vertical direction, Bearing, Horizontal speed, Vertical speed, Horizontal speed uncertainty, and Vertical speed uncertainty).

Version describes the protocol version of ULP. When a SUPL message is received, the receiving entity determines if the major version part specified in the message is supported by the receiving entity. A >Maj parameter indicates a major version, in the range 0 to 255 (e.g., “1”). A >Min parameter indicates a minor version, in the range 0 to 255 (e.g., “0”). A >Serv_ind parameter indicates a service indicator, in the range 0 to 255 (e.g., “0”).

LSA Version describes the latest LSA version available for the device to download. A >Maj parameter indicates a major version, in the range 0 to 255 (e.g., “1”). A >Min parameter indicates a minor version, in the range 0 to 255 (e.g., “0”): A >Serv_ind parameter indicates a service indicator, in the range 0 to 255 (e.g., “0”). A >Build parameter indicates an application build version, in the range 0 to 65535.

Status Code provides for different status codes, either error or information indicators. Exemplary status codes are as follows:

Error Indicator Used to indicate errors.
unspecified: Used to indicate the error is unknown.
systemFailure: System failure.
protocolError Protocol parsing error,
dataMissing: Needed data value is missing.
unexpectedDataValue: A datavalue takes a value that cannot be used,
posMethodFailure: The underlying positioning method returned a failure.
posMethodMismatch: No positioning method could be found matching requested QoP, SET capabilities and positioning method specified by LAMM.
posProtocolMismatch: No positioning protocol could be found available at LSA and LAMM.
targetSETnotReachable: The LSA was not responding.
versionNotSupported: Wrong ULP version.
resourceShortage: There were not enough resources available at the LAMM to serve the LSA or not enough resources available at the LSA for the session.
invalidSessionId: Invalid session identity.
unexpectedMessage: Unexpected message received.
nonProxyModeNotSupported: The LSA does not support “Non-Proxy” mode of operation.
proxyModeNotSupported: The LSA does not support “Proxy” mode of operation.
positioningNotPermitted: The LSA is not authorized by the LAMM to obtain a position or assistance data,
authNetFailure: The network does not authenticate the LSA. Only used in SUPL AUTH_RESP.
authSuplinitFailure: The SUPL INIT message is not authenticated by the LSA or the LAMM.
serviceNotSupported: Service Capability not supported.
incompatibleProtectionLevel: The Protection Level in the SUPL INIT message is not compatible with the protection level of the LSA.
insufficientInterval: The requested interval between fixes is not compatible with the capabilities of either the LSA or the LAMM.
noSUPLCoverage: The LSA lost SUPL coverage. This status code is used for V-LAMM to V-LAMM handover to indicate to the LAMM that the LSA lost SUPL coverage.
SETRegistrationError SET Registration request session has been error.
unknownSETType: The LSA can't find prefixed SETType
notAuthorized: Not authorized.
SETRegistrationOK: SET Registration request session has been ok.

Information Indicators used to indicate information:

consentDeniedByUsen User denied consent for location determination session.
consentGrantedByUser User granted consent for location determination session.
sessionStopped: The triggered session has been stopped by the network or the LSA.

Position describes the position of the SET. The parameter also contains a timestamp and optionally the velocity. A >Timestamp parameter indicates the time when position fix was calculated. A >Position Estimate parameter provides a position estimate. A >>Sign of latitude parameter indicates North or South. A >>Latitude parameter (an integer between 0 and 2**23 −1) is the latitude encoded value (N) derived from the actual latitude X in degrees (0 degrees to 90 degrees) by the formula: N≦2²³ X/90<N+1. A >>Longitude paramter (an integer between −2**23 and 2**23−1) is the longitude encoded value (N) derived from the actual longitude X in degrees (−180 degrees to 180 degrees) by the formula: N 2²⁴X/360<N+1. An >>Uncertainty ellipse (semi major, semi minor, major axis) optional parameter contains the latitude/longitude uncertainty code associated with the major axis, and the uncertainty code associated with the minor axis and the orientation, in degrees, of the major axis with respect to the North. A >>Confidence optional parameter (an integer between 0 and 100) represents the confidence by which the position of a target entity is known to be within the shape description (i.e., uncertainty ellipse for 2D-description, uncertainty ellipsoid for 3D-description) and is expressed as a percentage. An >>Altitude information optional parameter is present for 3D position information, and absent for 2D position information. An >>Altitude direction parameter indicates height (above the WGS84 ellipsoid) or depth (below the WGS84 ellipsoid). An >>Altitude parameter (an integer between 0 and 2**15−1) provides altitude information in meters. An >>Altitude uncertainty parameter contains the altitude uncertainty code. A >Velocity optional parameter indicates speed and bearing values as defined by the Velocity type.

A Position Method parameter describes the positioning method, selected from an exemplary group of: A-GNSS SET Assisted only; A-GNSS SET Based only; A-GNSS SET Assisted preferred (A-GANSS SET Based is the fallback mode); A-GNSS SET Based preferred (A-GANSS SET Assisted is the fallback mode); Autonomous GPS; Autonomous GNSS; AFLT; Enhanced Cell/sector; EOTD; OTDOA; or No position.

A SET capabilities parameter (not mutually exclusive) in terms of supported positioning technologies and positioning protocols. It is provided to the LAMM in a SET Registration Request. A >Pos Technology parameter defines the positioning technology from among the following exemplary definitions. Zero or more of the following positioning technologies (including those listed in the optional GANSS Position Methods structure) are possible in the given embodiments: SET-assisted A-GPS; SET-based A-GPS; Autonomous GPS; AFLT; E-CID; E-OTD; or OTDOA.

A Notification parameter describes the notification/verification mechanism to be applied. A >Notification type parameter indicates the type of notification from among the following: No notification & no verification; Notification only; Notification and verification (Allowed on no answer—if no answer is received from the LSA User the LSA assumes that user consent has been granted and proceed, Denied on no answer—if no answer is received from the LSA User, the LSA assumes that user consent has been denied and aborts); Privacy override (is used for preventing notification and verification of a performed position fix or position fix attempt in terms of log files etc. on the LSA). Only applicable to emergency location services. Since the LAMM does not support emergency location services in the present embodiments, privacyOverride is not used by the LAMM. For “Allowed on no answer” and “Denied on no answer”, the SET returns a response to the LAMM within 40 seconds of receiving the SUPL INIT. This allows the ST2 timer on the LAMM to be configured to take user response time into account along with SUPL INIT delivery time, secure session initiation, etc. An >Encoding type parameter is required when Notification type is set to Notification only or Notification and verification and when RequestorID or ClientName is used. A possible value is gsm-default, referring to the 7-bit default alphabet and the SMS packing. A >RequestorID optional parameter indicates an identity of the Requestor. A >RequestorType parameter indicates the RequestorID type. It is required if RequestorID is present. The RequestorID type can be one of: MSISDN; MIN; or MDN. A >ClientName optional parameter indicates the name of the location application. A >ClientNameType parameter indicates the type of the client name. It is required if ClientName is present. The type of the client name can be one of: MIN, or MDN.

A QoP (Quality of Position) parameter describes the desired Quality of Position. A >Horizontal accuracy parameter indicates a horizontal accuracy. A >Vertical accuracy optional parameter indicates a vertical accuracy. A >Maximum Location Age optional parameter indicates a maximum tolerable age of position estimates used for cached position fixes. It takes a value from 0 to 65535. A >Delay optional parameter indicates a value as defined for element Response Time.

A SessionID parameter is a unique value having two parts, an LSA value (SET Session ID, which is a part of Session ID pertaining to the LSA) concatenated with a LAMM value (LAMM Session ID, which is a part of Session ID pertaining to the LAMM).

For Network-Initiated flows, when sending a SUPL INIT to the LSA, the LAMM assigns a value to the LAMM Session ID and does not include the SET Session ID in the message. The LSA then assigns a value to the SET Session ID when it receives the message. Any further messages, the resultant combined Session ID is contained for the remainder of the session.

For device registration, when sending a SET Registration Request to the LAMM, the LSA assigns a value to the SET Session ID and does not include the LAMM Session ID in the message. The LAMM then assigns a value to the LAMM Session ID when it receives the message. Any further messages contain the resultant combined Session ID for the remainder of the session.

The Session ID allows for multiple simultaneous sessions on both the LAMM and the LSA. The main purpose of the Session ID is to allow both the LAMM and the LSA to distinguish between multiple simultaneous sessions. Taking advantage of this capability, the LAMM is capable of supporting multiple SUPL sessions with the same LSA over any number of one or more secure sockets.

A SET Session ID parameter is a session identifier, unique from the perspective of the LSA. This value is unique over all concurrently active ULP sessions on that particular LSA. This value may be reused by the LSA after the ULP session for which it is being used has ended. A SET ID parameter contains an LSA identity value, such as: MSISDN; MDN; MIN; or IMSI.

A LAMM Session ID parameter is a Session identifier, unique from the perspective of the LAMM. This value is unique over all concurrently active ULP sessions on that particular LAMM. This value may be reused by the LAMM after the ULP session for which it is being used has ended. This parameter is written into a 4-octet-string. The identity of the LAMM is contained in a LAMM ID parameter, which can be: IPAddress (IPv4; Pv6); or FQDN.

A Ver parameter. The LSA calculates a MAC value using HMAC-SHA1-64 of the transmitted SUPL INIT message. The FQDN of the LAMM server address is used as the key in the calculation. The MAC value is calculated as follows: MAC=H(LAMM Server FQDN XOR opad, H(LAMM Server FQDN XOR ipad, SUPL INIT)). SHA-1 is used as the hash (H) function. The output of the SHA-1 HASH function is truncated to 64 bits, i.e., the HMAC is implemented as HMAC-SHA1-64. The final output of HMAC-SHA1-64 only contains the 64 leftmost bits of the HMAC computation and the remaining bits are truncated.

Location Triggers include parameters defining Trigger Type, Trigger Params, and Periodic Triggers Params. The Trigger Type parameter defines the trigger type as: Periodic, or Area Event. The Trigger Params parameter can indicate: Periodic Params; or Area Event Params. The Periodic Triggers Params parameter is required if trigger type is set to Periodic. The Periodic Triggers Params parameter includes: Number of Fixes; Interval Between Fixes; and StartTime. The Number of Fixes parameter describes the number of fixes during the periodic triggered session (in the range 1 to 8639999). For compatibility with MLP and RLP number of fixes * interval between fixes does not exceed 8639999 (100 days). The Interval Between Fixes parameter describes the interval between the start of position fixes for a periodic trigger. Units are in seconds in a range 1 to 8639999, with a default of 60. The StartTime optional parameter indicates when the LSA is to start the first position fix. Start Time is interpreted relative to the current time, i.e., to the time when the message containing the parameter is received by the LAMM or the SET. If not present, the LSA is to start the first fix immediately. Units are in seconds in a range 0 to 2678400.

An Area Event Trigger Params parameter is required if trigger type is set to Area Event. The Area Event trigger can be one of the following types: Entering; Inside; Outside; or Leaving. Entering: The LSA reports to the LAMM when it first detects that it is inside the predefined area. If repeated reporting is present, the LSA then reports once more for each time it detects that it has re-entered the predefined area after having left in the meantime. Inside: The LSA reports to the LAMM when it is within the predefined area. If repeated reporting is present, the LSA reports at the received interval as long as the target set is Inside the area. Outside: The LSA reports to the LAMM when it is outside the predefined area. If repeated reporting is present, the LSA reports at the received interval as long as the target set is Outside the area. Leaving: The LSA reports to the LAMM when it first detects that it is outside the predefined area. If repeated reporting is present, the LSA then reports once more for each time it detects that it has exited the predefined area after having been inside again. An Area Event Type parameter describes the area event trigger type. This parameter describes what kind of event should trigger a report. Valid types include: Entering event type; Inside event type; Outside event type; Leaving event type. A Location estimate parameter has a value of “false”. If false, it indicates that the location estimates is not required. For SET-Initiated triggered services this parameter is not useful and therefore in this case it is ignored by the LAMM. The LAMM always sets this parameter to “true”. A Repeated reporting optional parameter defines the parameters for repeated reporting. If not present, only one report is sent. When repeated reporting is used, the SET and the LAMM maintain the triggered event session until the maximum number of reports has been sent, the stop time (if included) has been reached, or either the LSA or the LAMM has sent a SUPL TRIGGERED STOP or a SUPL END to end the session. A >Minimum Interval Time parameter defines the minimum time between reports from the LSA in an Area Event Trigger session. For repeated reporting, an area event trigger cannot be fulfilled unless the minimum time interval has elapsed since the last report. It has a range of 1 to 604800, with units in seconds and a default of 60. Note: The LSA has the default value for this parameter. The LSA supports a configurable number. A >Maximum Number of Reports parameter defines the maximum number of reports in an Area Event Trigger session, with a range of 1 to 1024. A Start Time optional parameter indicates the start of the period when the trigger condition is able to be fulfilled. Start Time is interpreted relative to the current time, i.e., to the time when the message containing the parameter is received by the LAMM or the SET. Start Time is OPTIONAL. If not present, a Start Time of 0 is used and the trigger condition is allowed to be fulfilled immediately. Units are in seconds, with a range of 0 to 2678400. A Stop Time optional parameter is interpreted relative to the current time, i.e., to the time when the message containing the parameter is received by the LAMM or the LSA. It indicates when the SET stop the triggered session if it has not already been stopped for other reasons. If not present, a Stop Time of 8639999 seconds after the start time is used. Stop Time is greater than Start Time (if present). Stop Time-Start Time is not more than 8639999 (100 days in seconds). Units are in seconds, with a range of 0 to Ser. No. 11/318,399. A Geographic Target Area List optional parameter defines a list of geographic target areas. A >Geographic Target Area parameter defines a geographic target area in terms of CircularArea.

A Notification Mode parameter defines the mode whether the notification and verification is based on location or not. This parameter can be of type Normal NotificationNerification.

The ULP uses ANS.1 extension to ensure backward and forward compatibilities. The LSA supports all ULP versions used by the LAMM deployed in the field. When the LSA receives a SUPL INIT message from the LAMM with a lower protocol version, the LSA rejects with a SUPL END and the ULP version in the SUPL END is set to the version supported by the LSA. When the LSA receives a SUPL INIT with higher or same protocol version, the LSA continues the session using its own protocol version. If the SUPL INIT also includes the minimum major version, the LSA rejects with a SUPL END when the major version it supports is lower than the minimum major version required for the service. The ULP version in the SUPL END is set to the version supported by the LSA.

Defined error mappings include the following:

protocolError: Protocol parsing error.
unexpectedDataValue: A data value takes a value that cannot be used.
posMethodFailure: The underlying positioning method returned a failure.
versionNotSupported: Wrong ULP version.
resourceShortage: There were not enough resources available at the LAMM to serve the LSA or not enough resources available at the LSA for the session.
invalidSessionId: Invalid session identity.
unexpected Message: Unexpected message received.
serviceNotSupported: Service Capability not supported.

As used herein, the term application refers to a location based service (LBS) external to a wireless carrier network that has access to subscribers. Authentication refers to the process of confirming the identity of an LCS client by verifying that the ID and password in a location request are identical to the ID and password in the Application Profile. Authorization refers to the process of allowing access to locations only to those entities permitted to access them within the constraints defined in profiles. Device refers to a mobile device that is defined to the LSA and has an associated subscriber. Network refers to a mobile network as defined by a network ID.

While the invention has been described with reference to the exemplary embodiments thereof, those skilled in the art will be able to make various modifications to the described embodiments of the invention without departing from the true spirit and scope of the invention.

1. A method of providing complex, secure location based services to a self-locating from wireless device, comprising:
establishing a secure connection between a location services agent (LSA), located on a given self-locating wireless device, to a network-based location agent management module (LAMM), location on a location based services server, comprising;
transmitting, from said LSA, an MLP SLIR message to said LAMM,
authenticating said LSA,
applying subscriber privacy against said given self-locating wireless device,
verifying that said LSA is not currently SUPL roaming,
initiating a location session between said LAMM and said LSA using SUPL INIT message;
establishing a valid position with said LSA on said given self-locating wireless device;
receiving a position response at said LSA, from said LAMM, using an MLP SLIA message.

2. The method of providing complex, secure location based services to a self-locating wireless device according to claim 1, wherein said valid position comprises:
a continuously repeated location request by said LSA on said given self-locating wireless device.

3. The method of providing complex, secure location based services to a self-locating wireless device according to claim 1, wherein said valid position comprises
a periodically repeated location request for said LSA on said given self-locating wireless device.

4. The method of providing complex, secure location based services to a self-locating wireless device according to claim 1, wherein said valid position comprises
an intermittently repeated location request for said LSA on said given self-locating wireless device.

5. The method of providing complex, secure location based services to a self-locating wireless device according to claim 1, wherein said position response is an area event comprising one of:
Entering a target area;
Inside a target area;
Outside a target area; and
Leaving a target area.

6. The method of providing complex, secure location based services to a self-locating wireless device according to claim 1, further comprising:
reporting an area alert message to said location agent management module (LAMM) from said location services agent first detects that said given wireless device is inside a predefined geographic area.

7. The method of providing complex, secure location based services to a self-locating wireless device according to claim 1, further comprising:
after said given wireless device is inside said predefined geographic area, reporting an area alert message from said location services agent once more for each time said given wireless device is detected as re-entering said predefined geographic area.

8. The method of providing complex, secure location based services to a self-locating wireless device according to claim 6, further comprising:
reporting an area alert message at a received interval as long as said location services agent detects that said given wireless device is inside said predefined geographic area.

9. The method of providing complex, secure location based services to a self-locating wireless device according to claim 1, further comprising:
reporting an area alert message from said location services agent to said location agent management module (LAMM) when said location services agent of said given self-locating wireless device first detect that said given self-locating device is outside a predefined geographic area.

10. The method of providing complex, secure location based services to a self-locating wireless device according to claim 9, further comprising:
after said given wireless device is first detected by said location services agent to be outside said predefined geographic area, reporting an area alert message from said location services agent to said network-based location agent management module (LAMM) one more each time said given wireless device is detected as re-entering said predefined geographic area.

11. The method of providing complex, secure location based services to a self-locating wireless device according to claim 9, further comprising:
reporting an area alert message from said location services agent at a received internal as long as said location services agent detects said given wireless device is outside said predefined geographic area.

12. Apparatus for providing complex, secure location based services to a self-locating wireless device, comprising:
means for establishing a secure connection between a location services agent (LSA), located on a given self-locating wireless device, to a network based location management module (LAMM), located on a location based services server, comprising;
transmitting, from said LSA, an MLP SLIR message to said LAMM,
authenticating said LSA,
applying subscriber privacy against said given self-locating wireless device
verifying that said LSA is not currently SUPL roaming,
initiating a location session between said LAMM and said LSA using a SUPL INIT message;
means for establishing a valid position with said LSA, said valid position, to said LAMM
means for returning, from said LSA, said valid position, to said LAMM; and
means for receiving a position response at said LSA, from said LAMM, using an MLP SLIA message.

13. The apparatus for providing complex, secure location based services to a self-locating wireless device according to claim 12, wherein said valid position
a continuously repeated location request by said LSA on said given self-locating wireless device.

14. The apparatus for providing complex, secure location based services to a self-locating wireless device according to claim 12, wherein said valid position comprises
a periodically repeated location request by said LSA on said given self-locating wireless device.

15. The apparatus for providing complex, secure location based services to a self-locating wireless device according to claim 12, wherein said valid position comprises:
an intermittently repeated location request by said LSA on said given self-locating wireless device.

16. The apparatus for providing complex, secure location based services to a self-locating wireless device according to claim 12, wherein said position response is an area event comprising one of:
entering a target area;
inside a target area;
outside a target area; and
leaving a target area.

17. The apparatus for providing complex, secure location based services to a self-locating wireless device according to claim 12, further comprising:
means for reporting an area alert message to said location agent management module (LAMM) from said location services agent of said given wireless device, when said location services agent first detects that said given wireless device is inside a predefined geographic area.

18. The apparatus for providing complex, secure location based services to a self-locating wireless device according to claim 17, further comprising:
means from reporting an area alert message from said location services agent once more for each time said given wireless device is detected as re-entering said predefined geographic area, after said given wireless device is detected as re-entering said predefined geographic area.

19. The apparatus for providing complex, secure location based services to a self-locating wireless device according to claim 17, further comprising:
reporting an area alert message at a received interval as long as said location services agents detect that said given wireless device is inside said predefined geographic area.

20. The apparatus for providing complex, secure location based services to a self-locating wireless device according to claim 12, further comprising:
means for reporting an area alert message from said location services agent to said location agent management module (LAMM) when said location services agent of said given self-locating wireless device first detects that said given self-locating wireless device is outside a predefined geographic area.

21. The apparatus for providing complex, secure location based services to a self-locating wireless device according to claim 20, further comprising:
means for reporting an area alert message once more for each time said given wireless device is detected as re-entering said predefined geographic area, after having entered said predefined geographic area after said given wireless device is detected outside said predefined geographic area.

22. The apparatus for providing complex, secure location based services to a self-locating wireless device according to claim 20, further comprising:
means for reporting an area alert message from said location services agent at a received interval as long as said location services agent detects that said given wireless device is outside said predefined geographic area.
